(19) United States
(12) Patent Application Publication
(10) Pub. No.: US 2015/0310209 A1
(43) Pub. Date: Oct. 29, 2015

(54) EXECUTING THIRD-PARTY APPLICATION

(71) Applicant: Alibaba Group Holding Limited, Grand Cayman (KY)

(72) Inventor: Maosen Zhang, Beijing (CN)

(21) Appl. No.: 14/694,942

(22) Filed: Apr. 23, 2015

(30) Foreign Application Priority Data
Apr. 25, 2014 (CN) 201410172373.7

(51) Int. Cl. G06F 21/53; G06F 9/48; G06F 21/57; G06F 9/445

(52) U.S. Cl. CPC G06F 21/53; G06F 8/60; G06F 9/4843; G06F 21/577; G06F 2221/033

(57) ABSTRACT

After a data request sent by a third-party developer is received, metadata description information of requested data is sent to the third-party developer for the third-party developer to develop a third-party application based on the metadata description information. Program information of the third-party application submitted by the third-party developer is received and the third-party application is deployed in a data container environment. The data container environment stores specific data needed during the execution of the third-party application. The third-party application is executed in the data container environment. The present disclosure solves a conflict between data security risk and opening of high value data.

### CROSS-REFERENCE TO RELATED PATENT APPLICATION

This application claims foreign priority to Chinese Patent Application No. 201410172373.7 filed on 25 Apr. 2014, entitled “Method and System for Executing Third-Party Application,” which is hereby incorporated by reference in its entirety.

### TECHNICAL FIELD

The present disclosure relates to the field of third-party application development, and, more particularly, to a method and system of executing a third-party application.

### BACKGROUND

A platform-type Internet application (for example, a certain e-commerce transaction platform) generally needs to introduce a third-party developer to provide more detailed and more vertical services for users (for example, seller users in the e-commerce transaction platform). For example, the third-party developer may collect and analyze information, such as a click rate, a cross-store click, an order transfer amount, and even chat records in a related instant messaging tool, to finally provide intuitive suggestions to the seller users. In other words, with respect to a user of a certain Internet application, the information, such as data analysis results, browsed in a web page of the Internet application is often provided by a third-party server.

In the prior art, the Internet application needs to disclose related data to the third-party developer through an open platform, and the third-party developer stores acquired data in its storage system to complete the development and subsequent operation of a service by using the data.

However, such an implementation at least has the following defects. First, after the data is acquired by a third-party developer, there are high risks of data leakage, abuse, misuse, or the like, because security control cannot be performed on the acquired data. Second, due to such security defects, the Internet application generally cannot disclose high value (risks such as privacy, security and competition) data to the third-party developer so that the functions that can be implemented by the third-party developer are limited. Furthermore, the third-party developer itself has a very limited capability of software and hardware processing, and therefore cannot implement the calculation processing on mass data.

For example, a certain third-party developer intends to provide a commodity replenishment prediction service to a seller user in a certain e-commerce transaction platform. In the prior art, the third-party developer needs to acquire required data from an open platform and inputs the data in an environment of the third-party developer for processing and calculation. With respect to the replenishment, it is necessary to predict the sales volume of the commodity, but due to the problem of data security, the open platform cannot provide the data required by a prediction model directly, such as industry commodity sales volume (involving industry data privacy) and attributes of people conducting transactions of the same category of commodities (involving industry and consumer data privacy). Furthermore, the replenishment channels and replenishment strategies of seller users are core competitiveness as well, and there is an issue of trust if they are provided to the third-party developer directly. In addition, the prediction model needs to take industry user behaviors, commodity transaction commodities, etc., into consideration, which results in a large data volume, and the third-party developer may not possess necessary software and hardware development environments. In brief, all of the above factors may prevent a third-party server from providing related service to a user in a transaction platform.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method and a system for executing a third-party application, and solves a conflict between data security risk and disclosure high value data.

The present disclosure provides an example method for executing a third-party application.

After a data request sent by a third-party developer is received, metadata description information of requested data is sent to the third-party developer for the third-party developer to develop a third-party application based on the metadata description information. Program information of the third-party application submitted by the third-party developer is received and the third-party application is deployed in a data container environment such as a data container. The data container environment stores specific data needed during the execution of the third-party application. The third-party application is executed in the data container environment.

The present disclosure provides an example system for executing a third-party application. The system may include the following units.

A metadata description information sending unit, after a data request sent by a third-party developer is received, sends metadata description information of requested data to the third-party developer for the third-party developer to develop a third-party application based on the metadata description information. An application deploying unit receives program information of the third-party application submitted by the third-party developer, and deploys the third-party application in a data container environment such as a data container. The data container environment stores specific data needed during the execution of the third-party application. An application executing unit executes the third-party application in the data container environment.

According to the example embodiments provided in the present disclosure, the present disclosure discloses the following technical effects:

The example embodiments of the present disclosure provide a data container system for a third-party developer, and store the data required in the calculation in a data container inside the system according to categories instead of sending the data to the third-party developer. The third-party developer, after completing the development of calculation logic or algorithm logic of the third-party application, also deploys the third-party application in this data container, so that the data and the operation on the data are all completed inside the data container and the third-party developer may provide corresponding calculation logic or algorithm without viewing specific data content, thereby solving the conflict between the data security risk and the opening of high value data.

Certainly, any product implementing the present disclosure does not necessarily achieve all of the above advantages at the same time.

### BRIEF DESCRIPTION OF DRAWINGS

To describe the technical solutions in the example embodiments of the present disclosure or in the prior art, the following briefly introduces the accompanying drawings needed in the example embodiments. Apparently, the accompanying FIGs in the following description are merely some example embodiments of the present disclosure, and a person of ordinary skill in the art may still acquire other drawings from those accompanying FIGs without using creative efforts.

FIG. 1 is a flow chart of an example method provided by an example embodiment of the present disclosure; and

FIG. 2 is a schematic diagram of a system provided by an example embodiment of the present disclosure.

### DETAILED DESCRIPTION

The following describes the technical solutions in the example embodiments of the present disclosure with reference to the accompanying FIGs in the embodiments of the present disclosure. Apparently, the described example embodiments are part of rather than all of the embodiments of the present disclosure. All other embodiments acquired by a person of ordinary skill in the art based on the example embodiments of the present disclosure shall belong to the protection scope of the present disclosure.

The example embodiments of the present disclosure provide a data container system to guarantee the security of the data and enable the third-party developer to provide more diversified services, and store the data required in the calculation in a data container inside the system according to categories instead of sending the data to the third-party developer. The third-party developer, after completing development of calculation logic or algorithm logic of the third-party application, also deploys the third-party application in this data container, so that the data and the operation on the data are all completed inside the data container and the third-party developer provides corresponding calculation logic or algorithm without viewing specific data content, thereby solving the conflict between the data security risk and the opening of high value data. The example implementation process will be described in detail in the following.

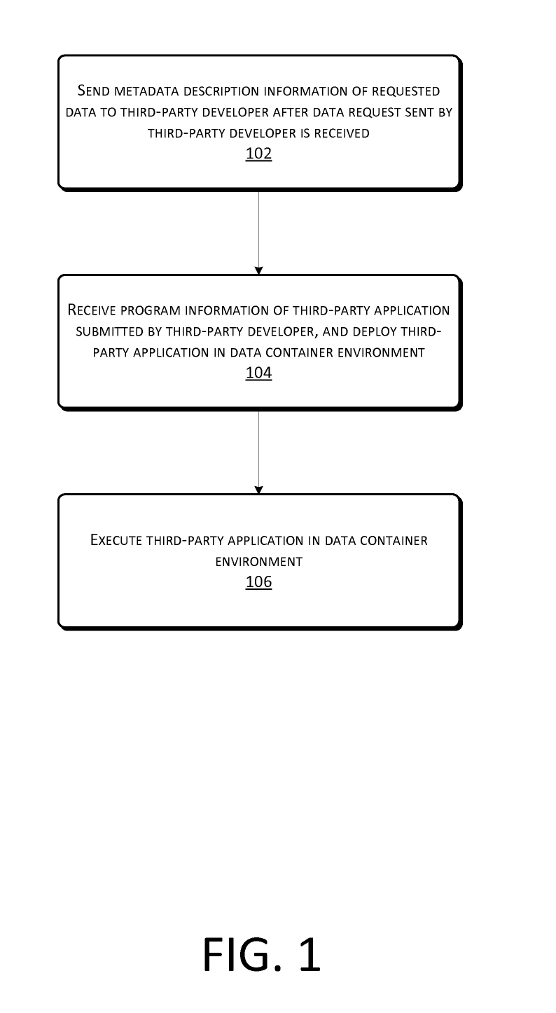

First, it should be noted that, since the data content will not be provided to the third-party developer directly, in the entire implementation process, the application platform needs to support the third-party server in the service development. After the development is completed, the application platform needs to support the subsequent deployment or the like as well. FIG. 1 refers to an example method for executing a third-party application and may include the following operations.

At 102, after a data request sent by a third-party developer is received, metadata description information of requested data is sent to the third-party developer for the third-party developer to develop a third-party application based on the metadata description information.

An interface for a background development, in which the third-party developer may perform code editing, debugging, etc., is provided to the third-party developer. For example, the interface may be in a form of a web page. That is, the third-party developer may directly log in the system of the application platform to enter a background development page to carry out specific development operations.

Since there is a large amount of data in the data container and the third-party developer often merely provides a service in a certain aspect, only a part of the data will be used in general. Thus, the data in the data container may be classified into a plurality of categories in advance, and the data of each category corresponds to one data subject. For example, in a certain e-commerce transaction platform, the data subject may include subjects such as delivery, reception, order management, and customer service. After the third-party developer accesses to the development platform, various selectable data subjects may be displayed to the third-party developer at first, and the third-party server may select a corresponding data subject according to a service needed to be developed. For example, if the third-party developer intends to develop a service relating to the order management, the data subject of the order management may be selected.

After the third-party developer selects a certain data subject, the metadata description information that may be used in the data subject may be provided to the third-party developer for the third-party developer to perform an application development. It should be noted that the data in the open platform is generally stored in a form of a data table (a table in a relation type database). Therefore, when the metadata description information is provided to the third-party developer, the information may include a name of the data table and field information in the data table. In other words, the third-party developer may know which fields are in the data table. For example, with respect to a data table A storing user information, the fields in the data table A include age, gender, or the like. In this case, a name of the data table A, and field names such as age and gender may be provided to the third-party developer. In this way, the third-party developer may develop specific logic in the third-party application based on those field names and in combination with a basic operation method of the data table. The basic operation of the data table may support various programming languages, for example, languages used for accessing to data, and querying, updating and managing the relation database system, such as JAVA and SQL, to implement operations on data of various fields in the data table.

In other words, the example embodiments of the present disclosure do not need to provide specific data in the data table to the third-party developer, and only provide the information about which fields are in the data table to the third-party developer. Of course, in an actual implementation, after the third-party developer develops a specific application, in order to perform a verification operation on the calculation logic of the application, the open platform may provide some sample data for the third-party developer. Such sample data may be some exemplary data, for example, formed by combining behavior data of the user several years ago. Since the data was acquired several years ago, and is formed by combining data fragments, generally, problems such as information leakage will not occur.

For some large third-party applications, in general a very large amount of codes will be required, and the process of editing the codes is complicated, and it is easy to make mistakes. In the example embodiment of the present disclosure, in order to simplify the development process, the third-party developer is allowed to divide an application into several sub-applications, and develop codes of each of the sub-applications respectively in the development environment, and finally associates each of the sub-applications with each other according to the dependencies between each of the sub-applications by using the open platform, to realize a corresponding third-party application together.

In addition, the third-party applications may be classified into different types. Corresponding development interfaces and various types of development portals for various types of applications are provided respectively. If the third-party developer wants to develop a certain type of application, the third-party developer will enter through a development portal of such type. After receiving a request of the user through the development portal, the open platform may display the corresponding development interface, and the third-party developer may perform works such as code editing and debugging in the interface. For example, the third-party application may be classified into calculation type application and algorithm type application. In this case, according to the specific entered interface, the open platform may identify the type of the correspondingly developed third-party application and send to a matched data container during the subsequent scheduling.

It should be noted that, the same third-party application developed by a third-party developer may be composed of a plurality of sub-applications, and each of the sub-applications may be applications of different types. Moreover the sub-applications may perform data transfer with each other.

Furthermore, it should be noted that, in the actual implementation, when a data request sent by a certain third-party developer is received, a review of such data apply may also be performed, which may include, for example, a review of the qualification of the third-party developer. Moreover, if user data is involved, a user authorization may be established as well. That is, the user is queried if the third-party developer is allowed to use the data of the user. If the user authorizes, corresponding metadata description information, sample data, etc. may be returned to the third-party developer. Otherwise, if no user authorization is acquired, no corresponding information will be returned to the third-party developer.

At 104, program information of the third-party application submitted by the third-party developer is received, and the third-party application is deployed in a data container environment. The data container environment further stores specific data needed during the execution of the third-party application.

After completing the development of a certain third-party application, the third-party developer may submit it to the open platform, and correspondingly the development platform may deploy the logic of the third-party application to the data container environment inside the open platform. Since the data container environment stores the specific data required during the execution of the third-party application, the third-party application may be executed in the data container environment. In this way, the specific process of data processing is completed inside the data container, and it is unnecessary to disclose the to-be-processed data to the third-party developer.

In the actual implementation, after the third-party application submitted by the third-party developer is received, a security review may also be performed on the application. For example, the techniques of the present disclosure determine whether there exists sensitive data, whether there exists a sensitive operation on data, etc. Then, if there is an operation on sensitive data or there is a sensitive operation, an interception may be carried out during data output, thereby further improving the security of the data. There may be a plurality of modes used for the security auditing. For example, in a simple mode, the filtering may be performed directly by using keywords or the like.

Alternatively, the techniques of the present disclosure determine whether the third-party application has transaction information of some specific commodity objects. Alternatively, for quantifiable data, the techniques of the present disclosure determine a percentage of a data amount of a certain industry data used by the third-party application against the total data amount. If the percentage reaches a certain value, other information of the industry may be deduced accordingly, thereby causing a leakage of the industry data, which indicates that there is a security problem.

Alternatively, when the third-party application includes information such as some user IDs, the techniques of the present disclosure determine whether the sensitive information such as real identity of the user may be acquired through deduction. If so, it also indicates that there is a security problem. In brief, when the security review is performed, a plurality of determining conditions may be set in advance. With respect to a certain third-party application, a determination may be performed by using the determining conditions. If a preset one or more conditions are hit, the third-party application is considered to have a security problem.

As described above, some third-party applications may have certain dependent relationships. For example, a certain application may be dependent on an execution result of another application, and thus this application needs to be executed after the execution of another application is completed. Furthermore, some third-party applications need to be executed in specific application scenarios. Therefore, before the deployment is submitted to the data container, each of the submitted third-party applications may be scheduled according to information such as dependencies and application scenarios to submit the third-party application that needs to be executed currently to the data container.

When the application that needs to be executed is submitted to the data container, some control commands may further be submitted, for example, a priority of the application and resource distribution condition (for example, a percentage of CPU and memory resources will be distributed for the application) so that the data container executes according to those control commands. The resource distribution condition may be based on the estimated input and output of the data and calculated according to a certain algorithm. Certainly, in the actual implementation, a determination may be made comprehensively according to information such as the number of resources ordered by the third-party developer.

At 106, the third-party application is executed in the data container environment.

After the third-party application is deployed in the data container, the third-party application may be executed in the data container. Specifically, during the execution, synchronous or asynchronous processing may be performed according to a task property of the third-party application. Correspondingly, the data container may be classified into a “distributed processing container” or a “synchronous processing container.” The former one is equivalent to distribute the task to a plurality of containers for separate execution, and finally there is a combination, which is generally used to process a task having a low requirement on timing. The latter one is to perform the processing immediately after the execution task is received, which is generally used for a task having a high requirement on timing. Therefore, the task property may be referred to as a requirement on timing. The task property may be designated by the third-party developer during the development.

After the execution of the third-party application is completed, the execution result may be provided to the user for use. There are multiple methods for providing the execution result to the user. One method is that the third-party developer acquires the execution result, and displays the execution result in the interface thereof. In order that the third-party developer acquires the execution result, the following operations will be performed: the computer-executable instructions or codes of the third-party application developed by the third-party developer may be encapsulated with an interface (such as a URL) according to an identification of output data. After the data container completes the execution, a corresponding relationship between the execution result and the URL may be recorded. When the third-party developer requests the execution result, the execution result may be returned according to the URL. In the specific implementation, many methods may be used.

For example, in one method, a portal for uniformly acquiring the execution result may be provided to each of the third-party developers, that is, each time when each of the third-party developers request the execution result, the request may be sent to the same URL, but the identification information such as an ID of the third-party developer and an identification of the output data requested this time must be carried at the same time. After receiving the request, the development platform may determine, according to the ID and the identification of the output data that are carried, a URL corresponding to the required execution result, and then the execution result may be returned to the third-party developer.

Alternatively, in another implementation, the URL corresponding to the execution result may be provided to the third-party developer directly, and, in this way, the third-party developer may request to acquire the corresponding execution result according to the actually corresponding URL.

In addition, in the actual implementation, the following situation may exist: sensitive data still exists in the execution result acquired from the execution in the data container. Under such situation, if the third-party developer acquires the execution result directly, there may still be a risk of a leakage of user data. For example, a certain third-party application is used for screening some users for promotion of a certain kind of information, and an execution result of this third-party application may include information such as contact information of the users. If the information is provided to the third-party developer, there still will be risks. Therefore, under such situation, in the specific implementation, the third-party developer may further be required to deploy foreground interface display logic in the data container. After the execution result is acquired, the execution result may be provided to the user directly according to the foreground interface display logic in the data container.

To facilitate the understanding, detailed description will be made through an example in the following.

The specific implementation may include the steps of:

Step 1: The third-party developer logs in the background of the open platform; at this time, the interface may display each of the selectable data subjects.

Step 2: The third-party developer applies for a certain data subject.

Step 3: The open platform performs a review of the application of the third-party developer, which is mainly used to determine if the third-party developer has the qualification of applying for the data subject.

Step 4: The data application is determined whether to passes the review. If not, a notification message of failure or the like is returned. If the data application passes the review, operations at Step 5 are performed.

Step 5: The third-party developer applies for sample data.

Step 6: The open platform sends an authorization review message to the user.

Step 7: The authorization is determined whether passed or not. If not, a notification message of failure or the like is returned. If yes, operations at Step 8 are performed.

Step 8: The third-party developer accesses to a development interface to develop a third-party application.

Step 9: After the development is completed, the third-party application is submitted to the open platform for review.

Step 10: The open platform performs a data security review on the third-party application;

Step 11: The data security review is determined whether passed or not. If not, a notification message of auditing failure or the like is returned. If yes, operations at Step 12 are performed.

Step 12: The third-party developer submits the third-party application to the open platform for the deployment.

Step 13: The open platform deploys the third-party application to the data container for the execution.

Step 14: An execution result is provided to the user for use.

In order to better understand the technical solution of the embodiments of the present disclosure, the development platform will be divided into a plurality of modules in the following, and the functions of each of the modules and associations between the modules are described respectively. For example, the open platform may include the following modules:

A login verification module: after the third-party developer logs in to the open platform by using pre-registered account information, the open platform may verify the identity of the third-party developer, and, after the identity verification is completed, grant a token to the third-party developer. The third-party developer may access to the system with the token.

An authorization verification module: the open platform may further verify the data rights and operation rights of the third-party developer, and, after the authorization verification is completed, grant the corresponding data rights and application development rights to the third-party developer.

A data application development module: integrates data application development environments, and provides a development interface for the third-party developer, in which code editing, debugging or the like may be performed. In the example implementation, the data application development module may be formed by two parts, which include a universal calculation type data application development sub-module and an algorithm type data application development sub-module. The third-party developer may select to access to a corresponding sub-module according to a category of a to-be-developed sub-program. In the development interface, the portals of two sub-modules may be provided, and, after access to the interface, the two sub-modules will have respective development interfaces. If a certain third-party developer wants to develop a calculation type sub-program, the third-party developer may enter from the portal of the universal calculation type data application development sub-module, thereby opening the development interface corresponding to the universal calculation type data application development sub-module. Similarly, if the third-party developer wants to develop an algorithm type sub-program, the third-party developer may enter from the portal of the universal algorithm type data application development sub-module, thereby opening the development interface of the universal algorithm type data application development sub-module.

Major functions of the universal calculation type data application development module may include, for example, as follows:

a) Application item management: including addition, deletion, modification, searching, sharing, authorization, cooperation, or the like relating to the application items.

b) Code development environment interface, which includes, for example:

i. Code development editor;

ii. Supplemental efficient tools such as code highlighting and grammar checking; and

iii. Metadata management: metadata detailed description (including table identification, a field name, or the like), data dependency, and interaction management;

c) Code sandbox environment management interface, which includes, for example:

i. Code simulated execution (test may be performed after the codes are developed to verify calculation logic); and

ii. Data set creation

d) Code management, which includes, for example, code version management and directory management. After the development of codes is completed, the open platform may store the codes in the code version management. If the codes need to be modified subsequently, a new version may be generated. When a copy of codes is stored, the open platform may encapsulate the codes into a corresponding program packet. With respect to program packets corresponding to different sub-programs in the same application, information such as application scenario requirements of each of the program packets, start conditions (for example, the packet needs to be started at a certain time point, needs to be started after the execution of a certain designated program is completed, or etc.) of each of the program packets, and dependency between the program packets may further be identified.

The start condition of the program packet may be designated by the third-party developer. The dependency between the program packets may either be designated by the third-party developer or may be acquired automatically by the open platform. For example, through an analysis of the codes of each of the program packets, the open platform obtains that the logic of a program packet 1 is to process Table a to generate Table b and Table c, and the logic of a program packet 2 is to process the Table b to generate Table d. As a result, the program packet 2 is determined dependent on the program packet 1, and therefore the dependency may be identified automatically.

e) Application management which includes, for example, application launch, application removal, and application state query.

f) Expense management which includes, for example, payment, renewal, settlement, clearing, and balance management.

Major functions of the algorithm type data application development sub-module may include:

a) Algorithm model management which includes, for example, addition, deletion, modification and searching, sharing, authorization, and cooperation.

b) Basic model base.

c) Data feature analysis environment which includes, for example, statistic distribution verification, feature extraction, and verification.

d) Model training management which includes, for example, model training and result verification.

A sandbox data container environment module provides a calculation environment for verifying codes and data sets, and includes, for example:

a) Code running environment which includes, for example:

i. Distributed code running environment (Map/Reduce program, SQL program)

ii. Algorithm running environment

b) Data environment: provides a data support environment for code running, a necessary database, a data set, a data set creation tool, or etc. The data may be sample data provided by the open platform. For example, the data of the users several years ago is combined together to generate data having the same data structure that is still not real data. Such data is provided to the third-party developer for verifying the codes developed by the third-party developer.

A task workflow scheduling module: responsible for scheduling, according to a task dependency and an application scenario requirement, the application submitted by the third-party developer, and submitting the application that needs to be executed to the data container environment (the data container monitors, by using a preset interface, a submitted request of the task workflow scheduling module, and therefore when the task workflow scheduling module finds that there is an application needs to be executed, a request may be sent through the interface of the data container). If the development module includes the calculation type data application development sub-module and the algorithm type data application development sub-module, during the scheduling, the application that needs to be executed may be sent, according to the calculation type application or the algorithm type application identified in the development process, to a “universal calculation container environment” or an “algorithm container environment” for execution. In addition, when submitting the application that needs to be executed to the data container, the task workflow scheduling module may further submit one or more control commands so that the data container executes according to those control commands.

The universal calculation container environment:

a) receives a universal calculation task submitted by the task workflow scheduling module, and submits the calculation task to a corresponding “distributed processing container” or “synchronous processing container” according to different properties of the tasks;

b) performs a monitoring, tracking, and data collecting of the task; and

c) communicates with a “data query middle layer” to complete the function of data query.

The algorithm container environment:

a) receives an algorithm task submitted by the task workflow scheduling module, and submits the algorithm task to the corresponding “distributed processing container” or “synchronous processing container” according to different properties.

b) “Basic algorithm packet” sub-module. When developing in the algorithm type data application development sub-module, the third-party developer may edit algorithm codes according to self-determined requirement. Alternatively, the open platform may also provide some basic algorithms for the third-party developer, and the third-party developer selects, on the basis of the basic algorithm, required features and adjusts parameters of the algorithm, thereby improving the development efficiency. Correspondingly, in the algorithm container environment, a basic algorithm executable calling module may be further provided. The basic algorithms may include, for example:

i. sorting algorithms

ii. clustering algorithms

iii. regression algorithms

A data security review engine: after the third-party developer completes the development of the codes and before the deployment of the codes in the data container, a security review may further be performed.

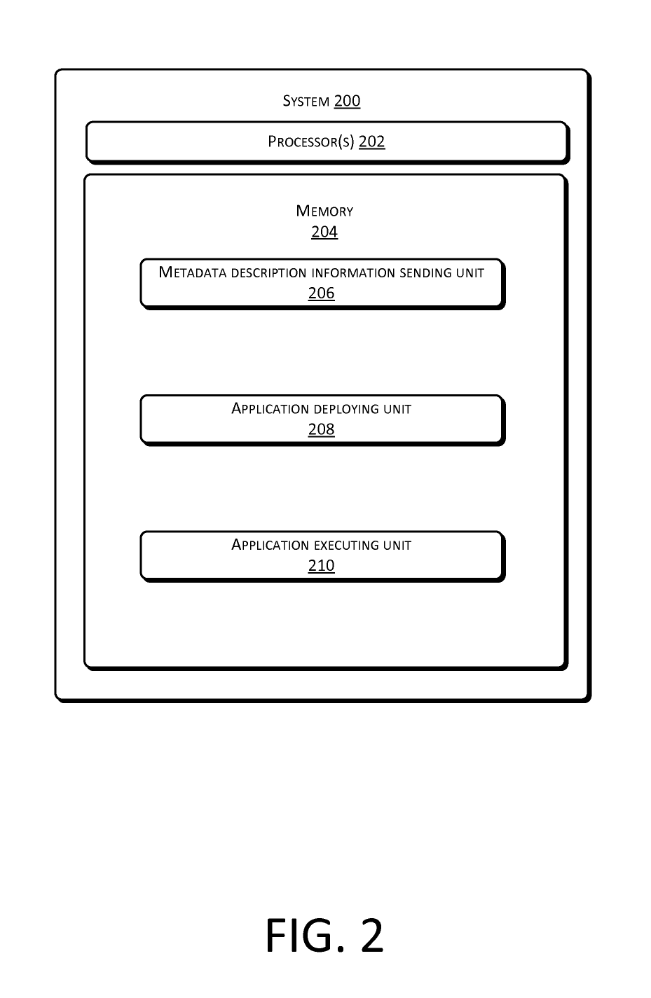

Corresponding to the method of executing a third-party application provided in the example embodiment of the present disclosure, an example embodiment of the present disclosure further provides an example system for executing a third-party application. Referring to FIG. 2, a system 200 may include one or more processor(s) or data processing unit(s) 202 and memory 204. The system 200 may further include one or more input/output devices and network interfaces (not shown in FIG. 2). The memory 204 is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 204 may store therein a plurality of modules or units including a metadata description information sending unit 206, an application deploying unit 208, and an application executing unit 210.

The metadata description information sending unit 206, after a data request sent by a third-party developer is received, sends metadata description information of requested data to the third-party developer for the third-party developer to develop a third-party application based on the metadata description information.

The application deploying unit 208 receives program information of the third-party application submitted by the third-party developer, and deploys the third-party application in a data container environment. The data container environment further stores specific data needed during the execution of the third-party application.

The application executing unit 210 executes the third-party application in the data container environment.

For example, the system 200 may further include a scheduling unit (not shown in FIG. 2) that schedules the third-party application according to a task dependency and/or an application scenario requirement.

The application deploying unit 208 may further deploy, according to a scheduling result, the third-party application that needs to be executed currently in the data container environment.

Furthermore, the system 200 may further include a security reviewing unit (not shown in FIG. 2) that, after the third-party application submitted by the third-party developer is received, perform a security review of an operation of the third-party application on data.

To facilitate the development of the third party, the system 200 may further include a sample data providing unit (not shown in FIG. 2) that, after the data request sent by the third-party developer is received, provides sample data to the third-party developer for the third-party developer to verify the logic of the developed third-party application.

As different application types correspond to different development portals, the system 200 may further include an interface providing unit (not shown in FIG. 2) that, when a develop request of a user is received from a certain type of development portal, provides a development interface o a corresponding type of application to the user.

As different application types correspond to different data container environments, the system 200 may further include an identifying unit (not shown in FIG. 2) that, after the develop request of the user is received from the certain type of development portal, identifies a type of the correspondingly developed third-party application.

The application deploying unit 208 may further, according to the type of the third-party application, deploys the third-party application in the data container environment corresponding to the type.

The application type includes a calculation type or an algorithm type. For example, the application executing unit 210 may further, according to a timing requirement of a task needed to be executed by the third-party application, perform a distributed or synchronous processing on the third-party application in the data container environment.

In addition, the system 200 may further include an encapsulating unit (not shown in FIG. 2) that, after the execution of the third-party application is completed, encapsulates the third-party application with an interface according to an identification of output data so that the third-party developer acquires an execution result of the third-party application according to the interface.

The system 200 may further include the following units (not shown in FIG. 2). A foreground interface logic receiving unit receives a foreground interface logic of the third-party application submitted by the third-party developer. An interface logic deploying unit deploys the foreground interface logic in a data container so that the execution result is displayed in a foreground interface after the execution of the third-party application is completed.

In brief, the example embodiments of the present disclosure provide a data container system for a third-party developer, and store the data required for the calculation in a data container inside the system according to categories instead of sending the data to the third-party developer, and the third-party developer, after completing the development of calculation logic or algorithm logic of the third-party application, also deploys the third-party application in this data container. Thus the data and the operation of the data are all completed inside the data container, and the third-party developer provides corresponding calculation logic or algorithm without viewing specific data content, thereby solving the conflict between the data security risk and the opening of high value data.

Based on the foregoing descriptions, a person skilled in the art may clearly understand that the present disclosure may be implemented by software in addition to necessary universal hardware platform. Based on such an understanding, the technical solutions of the present disclosure essentially or its portion contributing to the prior art may be implemented in a form of a software product. The computer software product may be stored in a computer storage medium, such as a ROM/RAM, a magnetic disk and an optical disc, and include computer-executable instructions for instructing a computing device (which may be a personal computer, a server, or a network device) to perform the methods described in some portions or all of a respective example embodiment of the present disclosure.

The example embodiments in the specification are described progressively. Identical or similar parts of the embodiments may be acquired with reference to each other, and each embodiment emphasizes a part different from other embodiments. Especially, a system or a system embodiment is described briefly since it is basically similar to a method embodiment, and related portions may be acquired with reference to the description of the method embodiment. The system and system embodiment described above are merely illustrative, in which the units described as separate parts may or may not be physically separate, and parts displayed as units may or may not be physical units, which may be located in one position, or may be distributed on a plurality of network units. A part or all of the units or modules may be selected according to actual needs to achieve the objectives of the solutions of the embodiments of the present disclosure. A person skilled in the art may understand and implement the present disclosure without using creative efforts.

The example method and system for executing a third-party application provided in the present disclosure are described in detail as above. The example embodiments of the present disclosure illustrate the principles and implementing operations of the present disclosure. The descriptions of the above example embodiments are merely intended to help understand the method and core concept of the present disclosure. A person of ordinary skill in the art may make variations of specific implementation and applications according to the principles of the present disclosure. The descriptions herein should not be interpreted to limit the present disclosure.

What is claimed is:

1. A method comprising:
receiving a data request for data;
sending metadata description information of the data to a third-party developer;
receiving program information of a third-party application submitted by the third-party developer;
deploying the third-party application in a data container environment; and
executing the third-party application in the data container environment.

2. The method of claim 1, wherein the metadata description information is for the third-party developer to develop the third-party application based on the metadata description information.

3. The method of claim 1, wherein the data container stores specific data for execution of the third-party application.

4. The method of claim 1, further comprising:
scheduling the third-party application according to a task dependency or an application scenario requirement.

5. The method of claim 4, wherein the deploying the third-party application in the data container comprises deploying the third-party application in the data container according to a result of the scheduling.

6. The method of claim 1, further comprising:
performing a security review of an operation of the third-party application on the data after receiving the program information of the third-party application submitted by the third-party developer.

7. The method of claim 1, further comprising:
providing sample data to the third-party developer to verify a logic of the developed third-party application.

8. The method of claim 1, wherein different application types of third-party applications correspond to different development portals.

9. The method of claim 8, further comprising:
providing a respective development interface corresponding to an application type of the third-party application.

10. The method of claim 1, wherein different application types of third-party applications correspond to different data containers.

11. The method of claim 10, further comprising:
identifying an application type of the third-party application; and
deploying the third-party application in a respective data container corresponding to the application type of the third-party application.

12. The method of claim 1, wherein an application type of the third-party application includes a calculation type or an algorithm type.

13. The method of claim 1, wherein the executing the third-party application in the data container comprises:
performing a distributed or a synchronous processing of the third-party application in the data container according to a timing requirement of a task to be executed by the third-party application.

14. The method of claim 1, further comprising:
encapsulating a result of the executing with an interface according to an identification of output data.

15. The method of claim 1, further comprising:
receiving a foreground interface logic of the third-party application; and
deploying the foreground interface logic in the data container to display a result of the executing in a foreground interface.

16. A system comprising:
a metadata description information sending unit that receives a data request for data and sends metadata description information of the data to a third-party developer;
an application deploying unit that receives program information of a third-party application submitted by the third-party developer and deploys the third-party application in a data container; and
an application executing unit that executes the third-party application in the data container.

17. The system of claim 16, where in the metadata description information is for the third-party developer to develop the third-party application based on the metadata description information.

18. The system of claim 16, wherein the data container stores specific data for execution of the third-party application.

19. One or more memories having stored thereon computer-executable instructions executable by one or more processors to perform operations comprising:
receiving a data request for data;
sending metadata description information of the data to a third-party developer;
receiving program information of a third-party application submitted by the third-party developer;
deploying the third-party application in a data container; and
executing the third-party application in the data container.

20. The one or more memories of claim 19, where in the metadata description information is for the third-party developer to develop the third-party application based on the metadata description information.
